(19) United States
(12) Patent Application Publication
(10) Pub. No.: US 2015/0278456 A1
(43) Pub. Date: Oct. 1, 2015

(54) Hygienic Enforcement and Nosocomial Diagnostic System (HEANDS)

(71) Applicant: International Business Machines Corporation, Armonk, NY (US)

(72) Inventors: Sergio A. Bermudez Rodriguez, Croton on Hudson, NY (US); Hendrik F. Hamann, Yorktown Heights, NY (US); Levente I. Klein, Tuckahoe, NY (US); Alejandro G. Schrott, New York, NY (US)

(73) Assignee: International Business Machines Corporation, Armonk, NY (US)

(21) Appl. No.: 14/225,708

(22) Filed: Mar. 26, 2014

(51) Int. Cl. G06F 19/00

(52) U.S. Cl. CPC G06F 19/325; G06F 19/327

(57) ABSTRACT

Techniques for acquiring and analyzing environmental and personnel presence, location and identification data from a health care facility to manage operations of the health care facility with regards to personnel tracking, patient comfort and/or enforcement of hygienic protocols are provided. In one aspect, a method of managing operation of a health care facility is provided. The method includes the steps of: acquiring data regarding i) environmental factors in the health care facility and ii) a presence, a location and an identity of personnel in the health care facility using a sensing platform system having a plurality of sensing points throughout the health care facility, wherein the sensing platform is configured to identify the personnel in the health care facility via radio-frequency identification (RFID); and analyzing the data to provide real-time analytics for managing operation of the health care facility.

### FIELD OF THE INVENTION

The present invention relates to managing operations of a health care facility such as a hospital, and more particularly, to techniques for acquiring and analyzing environmental and personnel presence, location and identification data from a health care facility to manage operations of the health care facility with regards to personnel tracking, patient comfort and/or enforcement of hygienic protocols.

### BACKGROUND OF THE INVENTION

The health care industry is under pressure to improve its performance and provide services in a quality-oriented fashion, while at the same time containing costs. In a health care environment such as a hospital, maintaining the highest performance standards within a reasonable budget requires that all aspects of the patient care—from the hospital facility itself to equipment to personnel, etc.—be managed in an extremely efficient and effective manner. This is a very complex task. For instance, one must take into account a vast array of factors such as assessing compliance of hygienic protocols, potential infection focus, personnel whereabouts, patient comfort, facilities functional optimization, etc.

While each of these factors might be assessed individually, to do so on a regular basis is impractical and certainly cannot be done in a timely manner. Thus, it would be helpful to have a single platform for monitoring and analyzing a multitude of such factors at one time. To date no such platform exists.

### SUMMARY OF THE INVENTION

The present invention provides techniques for acquiring and analyzing environmental and personnel presence, location and identification data from a health care facility to manage operations of the health care facility with regards to personnel tracking, patient comfort and/or enforcement of hygienic protocols. In one aspect of the invention, a method of managing operation of a health care facility is provided. The method includes the steps of: acquiring data regarding i) environmental factors in the health care facility and ii) a presence, a location and an identity of personnel in the health care facility using a sensing platform system having a plurality of sensing points throughout the health care facility, wherein the sensing platform is configured to identify the personnel in the health care facility via radio-frequency identification (RFID); and analyzing the data to provide real-time analytics for managing operation of the health care facility.

A more complete understanding of the present invention, as well as further features and advantages of the present invention, will be obtained by reference to the following detailed description and drawings.

### BRIEF DESCRIPTION OF THE DRAWINGS

FIG. 1 is an exemplary methodology for using the present sensing platform for managing operation of a health care facility such as a hospital according to an embodiment of the present invention;

FIG. 2 is a diagram illustrating an exemplary mote device module according to an embodiment of the present invention;

FIG. 3 is a diagram illustrating an exemplary configuration of the present sensing platform including a mesh network of sensors and a measurement and management technology (MMT) platform for data analysis according to an embodiment of the present invention;

FIG. 4 is a diagram depicting an exemplary scenario for which the present sensing platform might be implemented to locate hospital personnel and optimize hospital resources (equipment) according to an embodiment of the present invention;

FIG. 5 is an exemplary graph showing statistical data of number of entries in a patient room based on RFID tag (aggregated number) over time according to an embodiment of the present invention;

FIG. 6 is a diagram illustrating hand washing compliance metrics for 50 RFID tags in an exemplary hospital setting over a two day period according to an embodiment of the present invention; and

FIG. 7 is a diagram illustrating an exemplary apparatus for performing one or more of the methodologies presented herein according to an embodiment of the present invention.

### DETAILED DESCRIPTION OF PREFERRED EMBODIMENTS

As provided above, due to the complexity of factors involved in properly operating a health care facility such as a hospital, a comprehensive platform which provides means for overall managing hospitals by assessing compliance of hygienic protocols, potential infection focus, personnel whereabouts, patient comfort, and functional optimization is not known in the art. The absence of such a platform constitutes a missing link in the evolution path of the health care industry.

Advantageously, provided herein are techniques to record a comprehensive set of information based on an environmental sensing platform suitable to manage a health care facility such as a hospital. According to an exemplary embodiment, the platform is used to monitor the environment (e.g., temperature, humidity, presence of chemicals (such as disinfectants), etc.) in the common areas of the facility, i.e., patient rooms, operating areas, hallways, and also to monitor the presence, location, identification and amount of time health care providers, cleaning personnel, administrative staff and technical support people are present in these common areas. The present sensing platform continuously and in real time monitors the surroundings and records all events based on a set of scenarios which provides direct information suitable for health statistics and analytics which can be fed into a business intelligence tool or presented through reports, etc.

The present sensing platform will be described in detail below, however, generally the platform includes a means to sense (e.g., via a plurality of sensors) and relay data in a remote fashion by battery powered transmitters. A data logger-computer receives both local (from within the facility) and remote data (outdoor humidity, temperature, air quality, weather forecast, etc.). Within the facility, in addition to monitoring environmental conditions the present sensing platform is preferably configured to, for example, detect the presence of hospital personnel and visitors in patient rooms, monitor the amount of time health care providers spend in a patient's room, detect compliance with hygienic rules by hospital personnel, daily disinfection used in patients' rooms, patient comfort levels (a qualitative metric given by, for example the room temperature and the average and peak acoustic noise level during the night time) etc. All of the data collected by the sensing platform can be time stamped and, if so desired, can be fed directly into statistical tools run internally at the hospital and/or, if so desired, metrics run by public health monitoring institutions.

Conventional solutions may include personnel taking measurements, such as temperature, humidity, etc., throughout the facility, making assessments of conformance to hygienic procedures, etc. It is very time consuming, however, to acquire data in this manner. The data acquired is not in real-time. Further, in order to manually assess the entire facility in this manner, the data points acquired must be spatially sparse. With a health care facility, such as a hospital, it is important to have current data as conditions can change and situations can unfold rapidly in such a setting. Further, a facility, such as a hospital, might have areas to which an assessor cannot gain access. For instance, taking measurements in patient rooms or operating rooms may be intrusive and thus not possible. Therefore, the data collected with conventional approaches might not be as thorough as needed to properly assess the conditions in the facility.

Thus, the ability to pin-point environmental/operating conditions in a facility in real-time are substantially limited with conventional approaches. With that in mind, some notable advantages/benefits of the present techniques include 1) the ability to simultaneously acquire patient comfort data, facility wide environmental conditions, hygienic protocol, occupancy, and people locations; 2) data communication (e.g., data transmitted from the sensors to a base station—from where it goes to a central repository) occurs at 2.4 GHz eliminating possible interference with medical equipment operating frequencies (MHz range); 3) data acquisition is triggered only when an event of interest occurs; 4) power consumption for the proposed solution is smaller than existing wireless communications (e.g., due to the mote operation optimization for low power consumption—see below); 5) RF radiation from sensing point is reduced compared to traditional WiFi networks (given that the motes operate using a different standard and a very small fraction of the RF power); 6) the number of sensors per point of interest is increased 5 times (measuring temperature, humidity, noise, air quality, presence, occupancy, etc. at the same time) compared to a traditional single measurement sensor in a given location, moreover spatial resolution can be increased by placing an extra wireless node; 7) multiple checks and redundancies are built into the platform to minimize false signal or data misinterpretation; 8) sensing points (or motes with multiple sensors) can be localized to within 5 feet in the facility based on the mesh network thus sensing points can be automatically located within the facility; 9) the sensing platform has a reconfigurable architecture, and the rearrangements of sensing points do not require any rewiring of the health care facility (i.e., as would be required for fixed location sensors); 10) all acquired data points are time stamped and the wireless network is time synchronized; 11) real time analytics on the data collected is preferably achieved using the same platform that measures the data thus minimizing error and data misplacement, via the MMT system (see below).

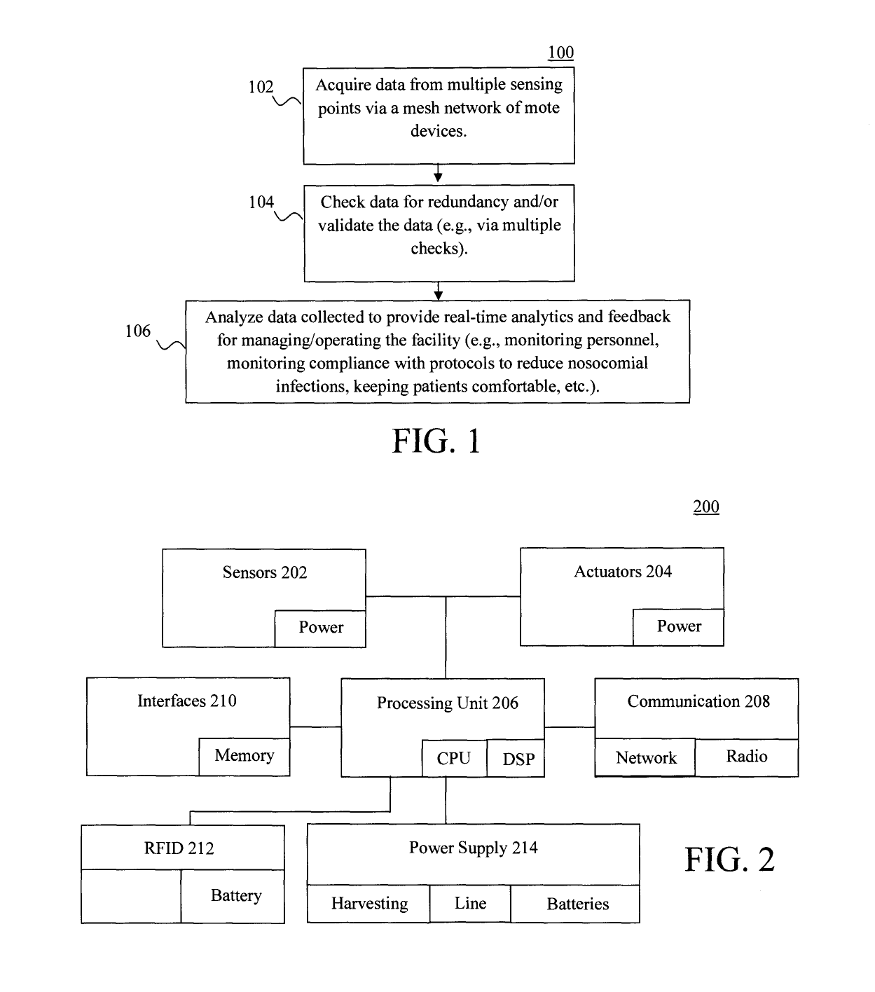

A general overview of the present techniques is provided by way of reference to FIG. 1 which is an exemplary methodology 100 for using the present sensing platform for managing operation of a health care facility such as a hospital. As shown in FIG. 1, in step 102, data from real-time events is acquired from multiple sensing points. As will be described in detail below, the present techniques support a large range of environmental sensing systems for temperature, humidity, noise, presence sensing, air flow, pressure, air quality, state of actuators, RFID etc. As will be described in detail below, in an exemplary embodiment the present techniques utilize a mesh sensing network with one or more mote device modules (also referred to herein as “mote devices” or simply as just “motes”). Each mote device module contains at least one sensor, and preferably the capability to store, process, and/or (wirelessly) transmit data collected by the sensor. See for example FIG. 2 described below. Each mote device in the mesh network can communicate with any of the other mote devices in the network and/or with one or more external data collecting/analyzing systems. Further, the network may be able to acquire information from one or more external (i.e., outside of the facility) data sources, including but not limited to, weather forecast services or internal (i.e., inside the facility) data sources, for example activity programmed by nurses, doctors and/or other hospital staff.

Advantageously, as highlighted above, the present sensing platform system employs low power devices and analytics. For instance, as will be described in detail below, the sensors may be only activated when the particular sensing subject matter is present. For example, sensors in the network that sense the presence of a person (also referred to herein as “presence sensors”—with one specific example of a presence sensor being a motion sensor) will only be active when a person is in proximity to the sensor. The presence sensor may then (via the mesh network) communicate with/activate a RFID sensor in the network to acquire the person's identity. This capability is especially important in a hospital setting, for instance, when certain personnel are required to be at a certain location at a certain time (e.g., doctors/staff needed in an operating room to perform a certain operation) and verification is needed that everyone is in fact present.

In step 104, the data collected is processed for redundancy and/or to validate the readings. Here redundancy in sensing gives assurance that the event is happening. For instance, in an actual implementation of the mesh network of sensors, it is possible that one or more sensors might be faulty and produce faulty readings. In order to ensure that the readings obtained reflect actual conditions within the facility, redundancy is one preferred technique to use. To use a simple example, if one sensor is producing a reading that is not commensurate with any other sensors, then it may call into question the validity of that sensor reading. Conversely, when multiple sensors are reporting the same value, then it may be assumed that the sensor readings are accurate.

Another additional measure that might be taken to validate the readings is through multiple checks. For instance, multiple readings may be taken at a single location. Comparison of the readings can reveal whether the sensors are producing valid results. Take for instance, the situation where multiple temperature readings are taken for a given location and each reading registers similar temperatures, then it may be assumed that the temperature readings taken are valid. If on the other hand a single (of multiple) reading is significantly different from the rest, then it may trigger an inquiry as to whether the sensor(s) has registered a faulty value.

As highlighted above, the present techniques supports a large range of sensors, including, but not limited to, temperature, humidity, noise, presence sensing, air flow, pressure, air quality, state of actuators (e.g., if an actuator is engaged a device is active, and if the actuator is not engaged the device is off or inactive), RFID, etc. sensors. By way of example only, one or more of these sensors used in the mesh sensor network are commercially available sensors.

In step 106, the data collected from the sensors is analyzed and used to provide real-time analytics and feedback. For instance, as will be described in detail below, in the context of a hospital, the sensor data collected may be leveraged in conjunction with suitable health statistics to provide feedback regarding optimizing personnel management (such as in surgical room settings), patient comfort (based, for instance, on temperature, nighttime noise levels, etc.), sanitary factors (such as compliance with hand washing rules so as to reduce the spread of infection).

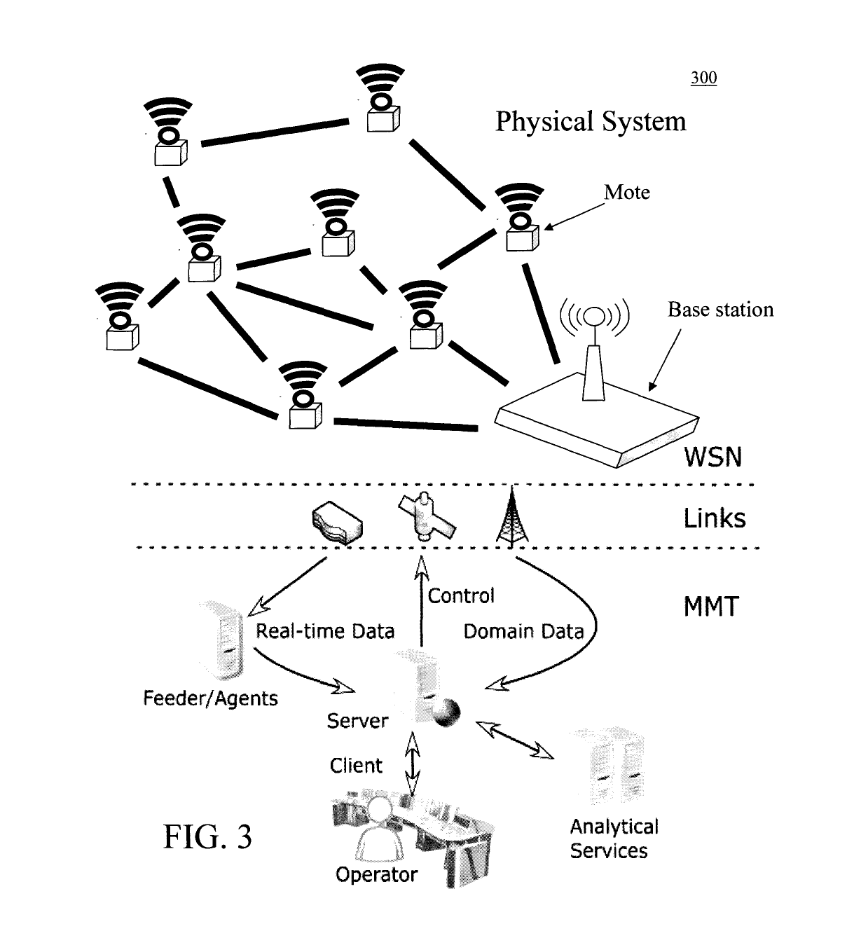

As will be described, for example, in conjunction with the description of FIG. 3 below, a measurement and management technology (MMT) platform is used for data analysis which employs a JAVA based software platform to provide real-time analytics and feedback. A low power wireless monitoring system controls the sensors and transfers the information through the mesh network to a centralized data base that is updated in real-time. This property enables the sensors to monitor relevant information in a localized way, utilizing much lower power than systems which transmit directly to a computer via a WiFi router. Once the sensors are installed, the mesh network is created automatically and the radio transmitters in the motes will be in a sleep mode for most of the time (i.e., no RF radiation emission for 99.2% of the time due to the low duty-cycle of the radio transmitters in the motes, for example, transmitting a data payload during a few milliseconds every, e.g., 30 seconds, and sleeping the rest of the time) working at frequencies (e.g., 2.4 GHz) that will not interfere with medical equipment. Namely, as provided above, the sensors are preferably maintained in an inactive state (i.e., in a sleep mode) until a given sensing subject matter is present in proximity to the sensor. This feature minimizes the power consumption of the sensor mesh network and/or minimizes the amounts of RF radiation from the sensors. So, for instance, if there is no activity (no human around), then the motes do not transmit data. Whenever there is activity (nurse washing her hands) and a mote detects it, then the mote aggregates all the activity within, e.g., a 30 second window, and transmits it. An exemplary time interval for data transmission by the motes is from about 30 seconds to about 10 minutes—see below.

The MMT (see, for example, FIG. 3) maintains a database of sensor locations in the network, and the system can (optionally) be configured to localize all of its components such that if a sensing point is relocated the network will determine the new location of the sensor (e.g., to within a 5 foot accuracy in the x-y plane) and the MMT will update the location of that sensor automatically in its database. By way of example only, the automatic location capability comes from the radio transmitters inside the mote used for communication (see, for example, the description of the communications module 208 in conjunction with the description of FIG. 2, below), and it is based on RF signal pulse time of flight measurements between anchor motes (those whose location is known and are unmovable) and the mote of interest. Thus, in order to enable the automatic component (e.g., new sensors) localization feature, according to an exemplary embodiment, the mote infrastructure has some anchor motes (motes the location of which is fixed, i.e., the mote is unmovable) that will serve as reference points for the rest of the motes (e.g., containing the new sensor). The anchor motes can be, for example, motes attached to the wall along a corridor such that their location is know and they are not moved (e.g., relocating a dispenser would require a non-anchor mote to be moved). Techniques for measuring time of flight for RF signals are described, for example, in U.S. Pat. No. 6,466,168 issued to Ewan, entitled “Differential Time of Flight Measurement System,” the entire contents of which are incorporated by reference herein. Based on this data, the localization measurements of the reference/anchor motes (of fixed/known location) and the motes of interest (of unknown location) are relayed to the MMT, where a localization algorithm may be executed to determine the location of the motes of interest. This automatic localization process will avoid an expansive data base maintenance that has to be implemented for other environmental monitoring solutions where a sensing point location has to be introduced manually in a data base. It is noted that, while beneficial, automatic component (e.g., new sensors) localization capabilities are an optional feature of the system. Thus, embodiments are considered herein where fixed location/reference anchor motes are not present in the system and/or the system does not have automatic localization capabilities.

A description of how the above-described sensor mesh network-based platform is applicable to monitoring and managing operations of a health care facility, such as a hospital, is now provided. Three main factors assessed using the present sensing platform are i) environmental factors in the facility, ii) identification/tracking of personnel, and iii) the real-time collecting and managing of the relevant data. These factors can then be leveraged using health statistics and analytics to, for example, optimize surgical room operation, patient comfort, hand wash compliance (so as to reduce infection spreading), etc.

Nosocomial infections are those which are acquired in a hospital (also referred to herein as hospital-acquired infections). Some basic steps can be taken to reduce the incidents of nosocomial infections. One fundamental step to reduce nosocomial infections is to insure that hospital personnel follow a strict hand washing regime, and that rooms are routinely cleaned/disinfected. Advantageously, hand washing in the hospital involves the use of hand washing chemicals (soap, sanitizers, and/or disinfectants) which can be detected by the appropriate chemical sensor(s). Similarly, washing patient rooms, surgical suites, etc. in a hospital also involves the use of disinfectants which can be detected by the appropriate chemical sensor(s). By way of example only, commercially available volatile organic compounds (organic chemicals), or isopropyl or ethyl alcohol (present in hand sanitizers), chlorine, bromine, and/or hydrogen peroxide sensors (components common in disinfectants) may be employed. In the case, for instance, where the hand washing chemical does not necessarily contain a chemical the presence of which may be detected with a sensor, such as some common hand washing soaps, then the (e.g., soap) dispenser itself may be outfitted with one of the mote devices to detect/sense when the dispenser is used to dispense (whatever medium it contains). A simple motion sensor (such as those commonly employed in touch-less faucets, hand dryers, etc.) might be employed to detect the presence of a hand under the dispenser and thereafter dispense the cleaner and register that the dispenser has been used. Further, the mote devices associated with the hand clear dispensers might contain multiple sensors, e.g., motion, chemical, etc. that may be redundant in the case where both the motion sensor and the chemical sensor both register that the hand washing chemical (e.g., disinfectant/sanitizer) has been dispensed. The present sensing platform preferably makes use of such sensors (in conjunction with sensors configured to identify the specific individual, e.g., RFID sensors—see below) to monitor which personnel are following the hand washing protocols and which are not, whether rooms are being properly and routinely cleaned, etc. With regard to enforcing the hygienic protocols in a health care facility, the present sensing platform system serves as a hygienic enforcement and nosocomial diagnostic system or HEANDS.

In a hospital setting for example, some relevant environmental factors which can be monitored using the present sensing platform include, but are not limited to, environmental sensing systems for temperature, humidity, noise, presence sensing (e.g., motion sensing), air flow, pressure, air quality, state of actuators, RFID, etc. Temperature, humidity, and noise sensing can all contribute to the goal of patient comfort. For instance, temperature and humidity measurements can be used to indicate whether or not the facility's air conditioning or heating system is operating properly in all areas of the hospital. Noise sensors can be used to detect whether noise levels are kept below an acceptable level, especially during quiet times such as at night when patients are trying to sleep. Since the data is taken in real-time and is time stamped, then a quick and easy assessment of noise can be made, and sources of excessive noise can be immediately addressed.

As highlighted above, presence (e.g., motion) sensing can be used to determine whether one or more individuals (such as hospital personnel, patients, etc.) are present at a particular location. Take for example the situation where an operation is about to take place in a particular operating room of the hospital. There is a certain group of hospital personnel needed for this operation, such as doctors, nurses, etc. Each hospital personnel and patient is given a badge and/or wrist bracelet fitted with a radio-frequency identification (RFID) chip which can be used to uniquely identify the person. Presence sensors in the operating room, as part of the present sensing platform, can be used to detect the presence of individuals in that operating room where the procedure is to take place. RFID sensors in the sensing platform can then be used to determine which individuals are present in the room at that time. If it is determined that one or more individuals needed for the operation are not present, then it is determined that the operation cannot begin because not all required parties are present. Further, by way of the present sensing platform, the presence of the missing individual(s) may, by way of the same process, be detected in another room/area of the hospital and thus that person can be easily and quickly found in order to begin the procedure.

Another measure to prevent nosocomial infections is through use of proper air filtration equipment. Namely, some nosocomial pathogens are airborne and thus can be spread through ventilation systems in the hospital. In order to minimize the spreading of such pathogens, air in the hospital is filtered and the clean air is circulated throughout the facility. When the air circulation/filtration systems are operating properly, there should be a certain level of air flow, pressure within the facility resulting in a certain suitable level of air quality. In this regard, the air flow, pressure, and air quality sensors on the present sensing platform can be used to take real-time measurement of these air quality parameters. This is also part of the nosocomial diagnostic capabilities of the present HEANDS system. Of course, clean air flow is also a factor in terms of patient comfort as patients would likely prefer having fresh air entering their rooms.

With the above exemplary parameters in mind, the present techniques and how they operate to assist in managing a health care facility are now described in detail. As highlighted above, the present sensing platform includes a mesh network of mote devices, wherein each mote device present at a node in the network includes one or more sensors. As highlighted above, exemplary sensors for use in a health care facility setting include, but are not limited to, temperature, humidity, noise, presence sensing (e.g., motion sensors), air flow, pressure, air quality, state of actuators, RFID, etc. sensors.

Each mote device module in the network includes at least one sensor, and preferably the capability to store, process and/or wirelessly transmit the data collected via the sensor(s) to one or more other mote device modules within the network and/or to any data collecting/processing facilities external to the network. FIG. 2, for example, is a diagram illustrating an exemplary mote device module 200. Mote device module 200 is representative of any of the mote devices within the network. By way of example only, all of the mote devices in the network may be configured as module 200.

Mote device module 200 is a modular mote design in that a variety of different sensors and other processing/transmitting capabilities can be easily integrated into the device. In this manner, different sensors can be easily integrated and/or removed from the network design. The mote module shown focuses on low-power mote technology (LMT). Namely, only a minimal power supply is needed, e.g., in line power or batteries, since the motes will remain in sleep mode (i.e., power to the sensor(s) in the mote device is turned off) when an object (person, RFID, certain smell, noise, etc.) is not proximate in position to the mote device. The sensor(s) in the mote device are only turned on (and thus use power only) when the object is within proximity of the mote device.

Further, low-power consuming wireless sensors are employed in the module design to reduce the power demands of the modules. Wireless sensors are described generally in Xia et al., “Wireless Sensor/Actuator Network Design for Mobile Control Applications,” Sensors, 7, 2157-2173 (October 2007) (hereinafter “Xia”), the entire contents of which are incorporated by reference herein. In fact, some commercially available RFID temperature sensors do not require a power source. See, for example, Kim et al., “No Battery Required: Perpetual RFID-Enabled Wireless Sensors for Cognitive Intelligence Applications,” Microwave Magazine, IEEE, vol. 14, issue 5 (July-August 2013), the entire contents of which are incorporated by reference herein, for a general description of RFID-based sensor systems. These types of sensors might be included in the mote module to further reduce the power demand.

As shown in FIG. 2, mote device module 200 includes a sensor module 202, an actuator module 204, a processing unit 206, a communications module 208, an interface 210 (e.g., for a human user and/or a machine such as a terminal, other mote, and/or extra sensor), an RFID module 212, and a power supply 214. It is notable that FIG. 2 illustrates an exemplary sampling of the modules that might be included in one (or more) of the present mode devices. However, not all the modules shown and/or one or more other additional modules may in fact be included in the present mote devices.

The sensor module 202 is representative of one or more sensors that may be included in a given one of the mote devices in the network. According to an exemplary embodiment, the sensor module 202 in each mote includes multiple sensors. By way of example only, for a hospital setting every mote in the network has at least i) a motion sensor, ii) an RFID reader, and iii) a Temperature and Relative Humidity sensor. Further, other sensors may be used in specific motes based on their location, e.g., a mote inside a patient room will add a volatile organic compounds sensor and the mote(s) at the hospital corridors will add acoustic noise sensors. Exemplary sensors for use in a health care facility (e.g., hospital) setting were provided above. As shown in FIG. 2, the sensors may be provided with a power supply, which can be battery-based and/or inline power. See description of power supply module 214, below.

The actuator module 204 of mote device module 200 is provided as a means to effect a physical response based on the data collected by the sensors. By way of example only, if the sensors module 202 records elevated temperatures in a patient's room, then the actuators module 204 may be employed to change the thermostat in the room. The advantage to this configuration is that both the condition and the response can be accurately pinpointed and addressed efficiently and effectively. For instance, it is possible that in response to a high temperature reading, hospital personnel can be dispatched to the room to adjust the thermostat. Here, the adjustment can be made automatically, without unnecessarily tying up hospital staff. As shown in FIG. 2, the actuators would be provided with a power supply, which can be battery-based and/or inline power. See description of power supply module 214, below.

The processing unit module 206 is provided to process the data collected by the sensors and to coordinate communication between the various modules of the mote device module 200. For instance, the processing unit module 206 can be configured to process the data collected from the sensors (i.e., by performing one or more steps of methodology 100—see above), communicate the data collected to one or more other mote device modules and/or to one or more remote processing systems, and/or match collected data with individuals (i.e., hospital staff, patients, etc.) via the RFID module 212 (see below). The processing unit module 206 includes a central processing unit (CPU) and preferably a display (DSP) for interaction with human users of the mote device module 200. The processing unit module 206 is provided with power via power supply 214. See below.

The processing unit module 206 can communicate with one or more other mote device modules in the mesh network, and/or with other external (outside the mesh network) processing or data collecting systems via the communications module 208. For instance, an external monitoring system(s) may be hooked into the mesh network via the communications module 208. Such monitoring systems may track hospital hygiene statistics, patient comfort data, etc. The communications module 208 may be configured to transmit data wirelessly (e.g., via radio transmitters) and/or via a wired network. Wireless capabilities means that the present mesh network can be adapted to any health care facility. Further, as highlighted above, the data communication by the present mesh network occurs at 2.4 gigahertz (GHz) (a common frequency for wireless devices) eliminating possible interference with medical equipment operating frequencies (i.e., which are in the megahertz (MHz) range).

The interfaces module 210 can be used as a user interface by which users can access certain functionalities of the mote. For example, some simple interfaces can be LED (light emitting diodes) that can be controlled by the processing unit 206 to indicate to a user if the mote is on or if its batteries require replacement, etc. Other simple exemplary interfaces can be a switch that can be used to inquiry a given status of the mote (e.g., if the communication module 208 is currently connected to a mesh network). A more complex user interface can be an LCD display that presents various metrics of the mote or system, e.g., remaining battery percentage or latest average hygiene compliance in the dispenser being monitored by the mote. Other types of interfaces can be a connection port for an external device, for example a machine (e.g., a computer or a different mote and/or other sensor), that can be used, for example, to retrieve information from a memory in the mote or for programs the firmware is running on the processing unit 206.

A RFID module 212 is included in the mote device module to enable the identification of individuals in the facility. As hospital personnel and patients move about the facility frequently, the individual(s) within proximity of a sensor changes over time. Thus, an effective way to link the data collected in a meaningful way with the relevant individuals in the facility, is via RFID tags. Namely, when acquiring data from the sensors, the mote device module 200 may also record (via RFID module 212) what individuals are proximate to the sensor(s). Hospital staff and patients may be each given unique RFID tags that can be embodied in a badge, wristband, etc. Thus, for instance, using the hand washing scenario outlined above, when the chemical sensors in the mote device module detect the hand washing disinfectant the mote device module may also record which individual(s) are proximal to the chemical sensors. Thus, the system may note that those individuals are properly following the hand washing protocols. Conversely, when the presence sensors detect that an individual is present (e.g., in a patient room), but the chemical sensor does not detect the hand washing disinfectant, then the RFID module 212 may be used to uniquely identify the individual(s) who might not be properly following the protocol.

Further, as provided above, the RFID capabilities may be leveraged to monitor the location of personnel and/or patients in the facility. One exemplary scenario provided above was that where a particular operation or other procedure requires that certain individuals be present at a certain location (for example, a certain group of doctors and staff are needed for an operation at a particular operating room). The presence sensors in conjunction with the RFID module 212 employed in the present sensor mesh network can detect not only that individuals are present in the operating room, but also which particular individuals are present, and furthermore, if an individual(s) is not present where in the facility that individual is.

The power supply module 214 provides power to the various other modules in the mote device module. A number of different power sources may be used, either alone or in combination. For instance, the power supply module 214 may simply employ in line power. However, for ease of placement of the modules, batteries may be employed. Batteries might also be in place as a backup in case of a power failure affecting in line power. Power may also be harvested using alternative energy sources, such as solar power. Thus, in that case inline and/or battery power can be supplemented by (e.g., solar) power, when available. Excess solar power generated can also be stored in the battery. Thus a multitude of different power configurations are possible.

FIG. 3 illustrates an exemplary configuration of the present sensing platform 300 that includes the above-described mesh network of sensors and a measurement and management technology (MMT) platform for data analysis. In the example shown in FIG. 3, the system is a wireless sensor network—WSN. As provided above, wireless sensors afford a greater flexibility in placement throughout a health care facility. However, embodiments are anticipated herein wherein one or more of the mote devices in the network include wired sensors. The mote device module 200 described in conjunction with the description of FIG. 2, above, is representative of any of the mote devices (labeled “Mote”) in FIG. 3.

As shown in FIG. 3, each of the mote devices in the network can communicate with one or more other mote devices. Each of the mote devices can also (wirelessly) communicate (directly and/or through one or more other mote devices) with a base station that collects the data from the mote devices. Basically, each mote device has the ability to wirelessly transmit data to other mote devices in the network and to the base station. For those mote devices in the network located farther from the base station, it may be necessary to relay the data to the base station via one or more other mote devices.

By way of a non-limiting example of a configuration that covers the scenarios explained above, the motes may be deployed in a hospital floor as follows. Every hand sanitizer or soap dispenser is fitted with a mote, and also a mote is placed in the entrance of every patient room. It is notable that there is typically a hand sanitizer/soap dispenser at the entrance to each patient room and in that case, only one mote (with multiple sensors at least one of which is for sensing the hand sanitizer—see above) is needed. Motes are installed in the hospital floor corridors at a given distribution such that elements can be accurately distinguished (e.g., hospital staff or noise sources). Again, hand sanitizers are typically installed at the hospital floor corridors, and in that case only one mote (with multiple sensors at least one of which is for sensing the hand sanitizer—see above) is required in those locations. Based on the above scenario, if a mote is installed at the hand sanitizer/soap dispenser at the entrance to the patient room (or alternatively one mote at the entrance to the room and another mote at a hand sanitizer/soap dispenser elsewhere in the room), one or more additional motes may be installed inside the patient rooms to help the tracking of hospital personnel in the room (see example involving personnel tracking—below).

As highlighted above, in the interest of minimizing power consumption by the mote devices in the network, a proximity method is preferably employed that turns power off to the sensor(s) in the mote device when an object (person, RFID, certain smell, noise, etc.) is not proximate in position to the mote device (i.e., the mote device is in a sleep mode). Power is turned on to the sensor(s) in the mote device when the object is within proximity to the mote device. In that regard, it is preferable that communications between the mote devices are limited to certain fixed time intervals so that most of the time the mote devices can (when not sensing an object) remain in a sleep mode and thus conserve power. By way of example only, the communications channel between the mote devices can occur at a fixed time interval of once every from about 30 seconds to about 10 minutes.

In the exemplary system shown in FIG. 3, the base station then transmits the data to an external (outside of the facility)/off-site processing facility via a communication link (labeled “Links”) supporting TCP/IP. Such communication link can be, for example, an Ethernet connection to the Internet, or a satellite connection, or a cellular infrastructure (e.g. 3G or LTE). The data processing facility may be a measurement and management technology (MMT) platform. See, for example, U.S. Patent Application Publication Number 2011/0040392 filed by Hamann et al. entitled “Measurement and Management Technology Platform,” the entire contents of which are incorporated by reference herein. MMT permits the use of real-time data and spatially dense three-dimensional domain data to build models of the facility.

As shown in FIG. 3, the MMT platform produces data that can be provided to the client and/or one or more other analytical services. For instance, in the context of a health care facility, the hospital management (a client) may wish to monitor the hand washing protocols in the hospital. The MMT platform can analyze the data from the chemical/RFID sensors (see above) and provide the hospital management client with statistics on hand washing compliance in the hospital. The data from the MMT may also be transmitted to other regulatory agencies (other external analytical services) such as multi-facility management systems, state health regulatory boards, etc., that monitor hospital compliance with protocols.

According to an exemplary embodiment, the present MMT platform, via its analytics and reporting components, can generate several types of reports detailing operations of the facility. The reports can be generated at regular intervals, such as once a shift, once a day, once a month etc. Reports may be generated for multiple locations in the facility. To give an illustrative, non-limiting example, the MMT might provide reports of hospital operational data once a shift separately for each floor of the facility, and additionally monthly (summary) reports for each floor, etc. As described below, reports may also be generated by the MMT on demand, when requested by hospital management, staff, etc.

The reports can be customizable, for example, to provide the information most pertinent to the persons who will view the reports. For instance, nurse managers are typically employed in hospital settings to manage the nursing staff, including monitoring hand washing and other hygienic protocols. Thus, when producing a report for the nurse manager for a given floor in the hospital, a webpage provided by the MMT can be the graphical interface for hourly estimates of hand hygiene compliance in a given floor of the hospital, so that the nurse manager of that floor can see the compliance of each nurse under her supervision at hourly intervals. In addition, for nurse managers, for example, the MMT can automatically generate daily, weekly, and/or monthly reports aggregating the information of a given floor in the hospital, such as compliance per job role or shift, statistics of compliance for different days of the week or patient rooms, etc. By comparison, for hospital executives, the MMT can automatically and periodically provide more broad information (e.g., via email), for example, comparisons between different hospital floors or statistics about compliance per job role, trends in compliance, etc. In addition, the MMT can generate reports on-demand, where the user can specify, e.g., via a webpage interface, the period of interest (dates) and/or the type of data she wants to see (compliance per job role, shift, day of the week, trend, etc).

The present techniques are further described by way of reference to the following non-limiting examples:

Surgical Room Workload Optimization

In this exemplary application, the present sensing platform is used to insure that necessary personnel are present when needed for a particular surgical operation or other procedure and to optimize available hospital resources, such as medical equipment. Say for instance that for a particular surgical procedure 20 medical personnel are needed to start the procedure, but one person is missing. As described above, presence sensors along with RFID identification capabilities of the present sensing system can be leveraged to identify the ID of people who are present and who is missing. This data can be collected by the base station and recorded, e.g., via the MMT. See, for example, FIG. 3.

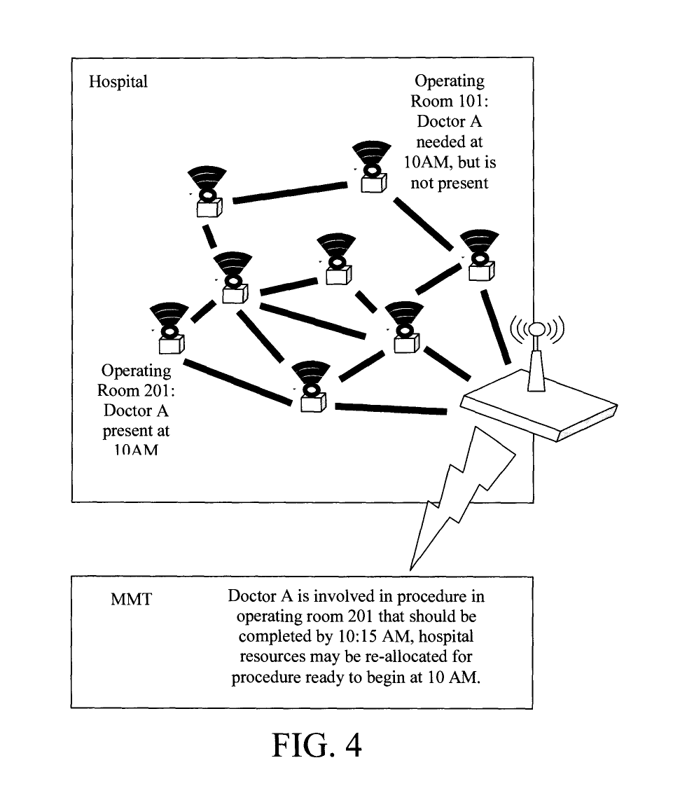

Further, the present sensing system can be used to locate the missing individual(s) within the health care facility (or can assess, if the individual cannot be found, the he/she might not be present in the facility), and once his/her location is identified make assessments of when the person might be available. For instance, the missing individual might be tied up with another task, such as another surgical procedure. The schedule of procedures that are to be performed at the facility for the day can be programmed into the MMT, e.g., by the system administrator. The start and end times can also be recorded, as well as data relating to the typical durations of each type of procedure. Thus, if the individual that is late is involved in another procedure for which the start time and approximate duration is known, then the MMT can estimate when that individual will likely be available. By way of example only, say doctor A is needed for a particular operation in room 101 at 10 AM. An assessment by the present sensing platform (e.g., via presence sensors and RFID identification) performed at 10 AM indicates: 1) who is present in operating room 101 at 10 AM, 2) that doctor A is not present in operating room 101 at 10 AM, and 2) that doctor A is actually present in operating room 201 at 10 AM. Based on the scheduled operations for that day, it can be then be deduced from the data collected that doctor A is involved in a procedure in operating room 201 and that procedure normally takes 30 minutes. If the start time of that procedure was 9:45 AM, then it can be estimated that doctor A should be available for the second procedure at about 10:15 AM. This exemplary scenario is depicted pictorially in FIG. 4. Of course, this is only an example meant to illustrate how the data collected by the present sensing platform may be utilized.

The absence of a required person at a particular location/time might also be attributable to tardiness. In that case, the present sensing platform can be used to identify who is missing (and for instance by process of elimination, i.e., if the individual is not tied up with a previous engagement) and stores the data. The present system can then be used to analyze, for example, how many times in the last 6, 12, etc. months that individual has been late. Conversely, the data collected (which identifies who is present at the proper time) can be also be used to identify those individuals who are punctual. This statistical data may be helpful in assessing how to assemble future teams for procedures.

This data regarding surgical procedures can also be used to optimize hospital resources, such as beds, chairs, medical equipment, etc. For instance, if a certain team of individuals is needed to perform an operation that requires a particular device, and one or more of the necessary individuals are missing (i.e., the procedure cannot begin), then the device can be reallocated to another procedure where all necessary individuals are present and ready to begin.

Monitoring Patient Rooms for Comfort

In this exemplary application, the present sensing platform is used to insure that the patient room environments are comfortable for the patients. By way of example only, via presence sensors and RFID identification, the present sensing platform can be used to maintain a record of and/or minimize the number of hospital personnel entering a patient's room. The idea here is that excessive visits by hospital personnel can be disruptive to a patient's comfort, especially at quiet times such as during the nighttime when patients are resting, and thus should be monitored and these interruptions minimized. Accordingly, as detailed above, the present sensing platform can be used to detect and record which personnel enter a given patient's room and when. Additionally, as provided above, the present mote devices may include noise sensors which can detect (and which can be recorded and logged) noise levels in patient rooms. To use an exemplary scenario to illustrate this point, if excessive (i.e., greater than a predetermined level of noise) is detected in a given patient room at 3 AM (as detected via the noise sensors), the present sensing platform might then be used to determine if/which hospital staff were present in the room at that time. An inquiry can then be made as to the nature of the noise.

Statistical data may be collected and stored for analysis of how many people enter a given patient's room over a given time period. See, for example, FIG. 5. FIG. 5 is an exemplary graph 500 showing statistical data of number of entries in a patient room based on RFID tag (aggregated number) over time. Other statistical data may include acoustic noise levels.

The present sensing platform can also be used (as described above) to sense environmental factors in patient rooms, such as temperature, humidity, CO₂ in the room to assure a comfortable environment (not too hot and not too cold), etc. Further, as provided above, the present mote device might be equipped with actuators to automatically alter the conditions in a patient room, e.g., whenever they fall outside of a predetermined range. Thus, for instance, when the sensing platform detects temperatures in a patient room that are greater than a preset limit, then the sensing platform might automatically lower the thermostat.

Further, certain protocols need to be followed when a patient has a contagious/infectious disease in order to minimize the chances for hospital-acquired infections. For instance, a negative air pressure should be maintained in rooms for contagious patients. As provided above, the present sensing platform may include air pressure sensors and thus can be used to monitor negative pressure compliance.

Patient comfort can also be related to how much attention the patient gets from doctors and nurses. Using the same above-described presence sensing and identification capabilities of the present sensing platform, the amount of time a doctor and/or a nurse spends in a patient's room can be detected and logged. Further, if so desired, the patient can be given access to this data, for instance on a display, to confirm for the patient that he/she is being adequately attended to.

Hand Washing Compliance

As provided above, adherence to proper hand washing protocols is a key factor in limiting nosocomial infections. In this exemplary application, the present sensing platform (HEANDS) is used to insure that these hand washing protocols are followed by hospital personnel. According to an exemplary embodiment, each patient room in the facility is equipped with a hand sanitizer dispenser and an RFID reader. As provided above, the RFID reader can be included as part of the present mote device modules.

When a hospital personnel is present (detected, e.g., based on the above-described presence sensors) and uses the hand sanitizer (as described above use of hand sanitizer can be detected, for example, based on chemical sensors in the mote devices that detect the disinfectant or other chemicals in the hand sanitizer and/or by way of motion sensors that detect that the dispenser has been used to dispense, e.g., a medium such as a soap which is not detectable via a chemical sensor), the present sensing platform will record the time, event (i.e., chemical sanitizer detected, motion associated with dispenser being used to dispense its contents, etc.), and the ID of the personnel. In the same manner, it can also be logged when personnel is present but does not use hand sanitizer. For instance, the presence of the personnel can be detected, but the absence of sensing any of the sanitizer and/or dispenser remains inactive—i.e., no dispensing motion—can be used to deduce that the personnel present did not follow the hand washing protocols.

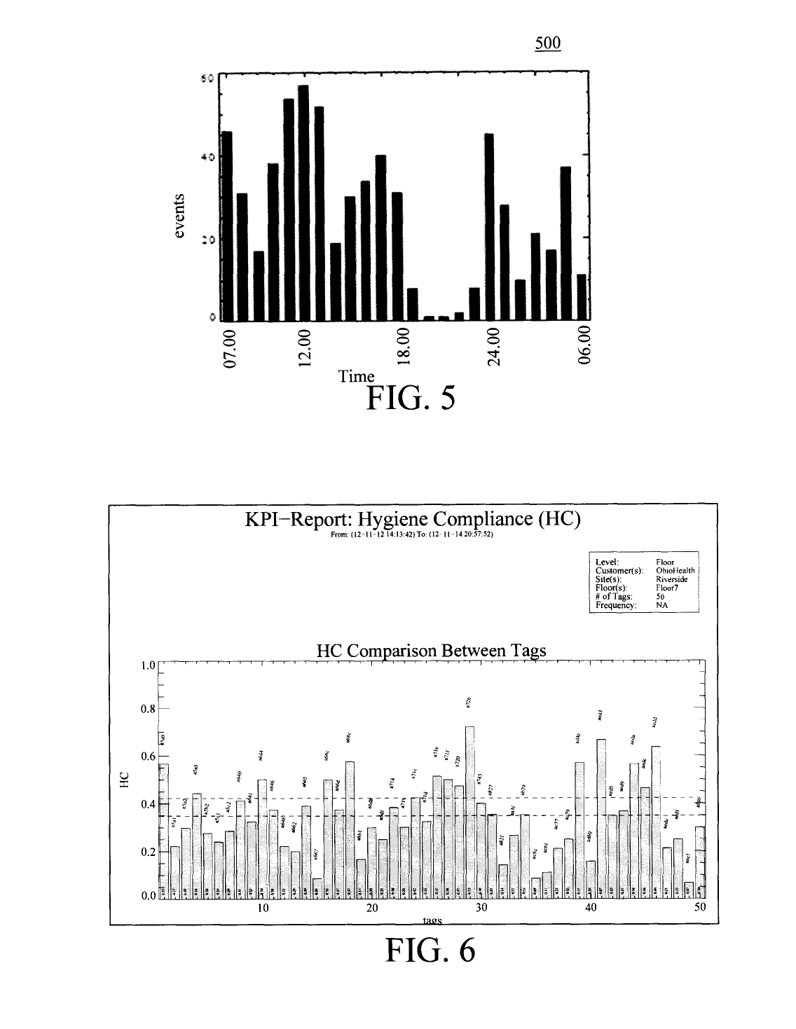

The real-time analytics capabilities of the MMT platform can be used to identify the number of compliances of the hand washing protocols for a certain shift. The number of non-compliances can then be addressed to insure adherence to hand washing protocols, and thereby reduce the nosocomial infection rates. By way of example only, FIG. 6 is an example of hand washing compliance metrics for 50 RFID tags in a hospital (individual tags) for a two day period. The tag numbers are plotted on the x-axis and hygiene compliance (HC)—i.e., hand washing compliance is plotted on the y-axis. Such metrics permit comparison of hygiene compliance between tags.

Monitoring Room Cleaning Procedures

In the same manner as described above with regard to hand washing compliance, the present system can be used to (via presence/motion and/or disinfectant chemical sensing capabilities—as described above) monitor compliance with protocols for cleaning patient rooms, operating rooms, common areas, etc. In addition to sensing and identifying personnel and/or the presence of disinfectant chemicals as in the hand washing example above, one may (in the case of room./facility cleaning protocols) further monitor the duration (period of time) during which the system senses a disinfectant, cleaning chemical, etc. at a certain location in order to ascertain compliance with cleaning protocols. For instance, in order to ensure proper cleaning is done, hospital protocols might dictate that a minimal amount of time must be spent cleaning a patient room. This cleaning procedure involves certain cleaning chemicals, disinfectants, etc. If, via the present sensing system, the disinfectant (used to clean patient rooms) is detected in a patient room for a certain duration then it can be assumed that room was being cleaned during that period of time. The MMT can take that duration data and compare it with the (predetermined) minimum standard duration set forth in the hospital protocol. Absent a set protocol (or as an additional guide), the MMT might take the duration data acquired and compare it with an average (cleaning) duration throughout the hospital to provide managers with statistics of cleaning operations by floor, shift, personnel, etc. Therefore, an absence of the cleaning chemicals and/or the presence of the cleaning chemicals for a duration less than a specified minimum duration and/or a less than average duration can be used to indicate non-compliance with cleaning protocols.

Monitoring Location of a Healthcare Provider and/or Equipment

As highlighted above, the presence (e.g., motion) sensing and RFID identification capabilities of the present sensing platform can be leveraged to locate individual personnel (or equipment) throughout the facility, e.g., in the instance where the personnel and/or equipment is needed for a certain task, such as an operation or other procedure. Personnel and resources, such as hospital equipment, can be assigned unique RFID tags. Here in this exemplary application, the same concepts are used to track movements of personnel in the facility in order to manage patient care procedures.

For instance, knowing how many rooms were covered during a particular shift is important to be able to allocate the proper number of personnel to insure that adequate attention is provided to each patient. Another related metric is the amount of time (time interval) was spent in each room. As described in detail above, the present sensing platform can be used to track personnel throughout the facility. The presence of a given staff member at a location is logged along with the time. From this data it may then be determined the time interval movement from one location to another (i.e., from one patient room to another).

It is often the case in a hospital setting that patients are to receive medications at prescribed times. Thus, another aspect of personnel tracking might be determining whether hospital personnel was present (i.e., to administer the medication) at the proper time.

In the case of a resource, such as piece of surgical equipment, a unique RFID tag affixed to the equipment may be used (via the present sensing platform) to identify the location of the equipment. Say, for instance, that a particular device (e.g., an x-ray machine) is needed for a surgical procedure, and the particular device is found (via the present techniques) in another operating room in which another scheduled surgical procedure is being performed. Data regarding when the other surgical procedure might be completed (and hence when that equipment might be available) and/or the location of other suitable x-ray equipment in the hospital which may be used instead can be garnered via the present sensing platform.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

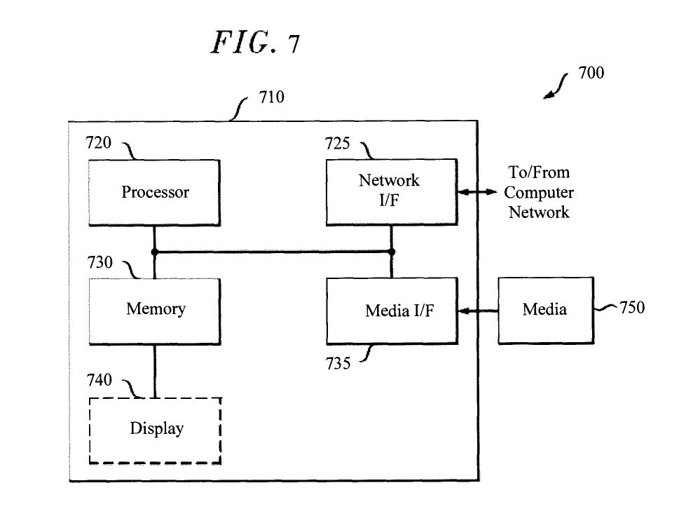

Turning now to FIG. 7, a block diagram is shown of an apparatus 700 for implementing one or more of the methodologies presented herein. By way of example only, apparatus 700 can be configured to implement one or more of the steps of methodology 100 of FIG. 1 for using the present sensing platform for managing operation of a health care facility such as a hospital. In one exemplary embodiment, apparatus 700 is an MMT platform (as described above) configured to receive/transmit and analyze data collected by the sensor network. See also FIG. 3, described above.

Apparatus 700 comprises a computer system 710 and removable media 750. Computer system 710 comprises a processor device 720, a network interface 725, a memory 730, a media interface 735 and an optional display 740. Network interface 725 allows computer system 710 to connect to a network, while media interface 735 allows computer system 710 to interact with media, such as a hard drive or removable media 750.

Processor device 720 can be configured to implement the methods, steps, and functions disclosed herein. The memory 830 could be distributed or local and the processor device 720 could be distributed or singular. The memory 730 could be implemented as an electrical, magnetic or optical memory, or any combination of these or other types of storage devices. Moreover, the term “memory” should be construed broadly enough to encompass any information able to be read from, or written to, an address in the addressable space accessed by processor device 720. With this definition, information on a network, accessible through network interface 725, is still within memory 730 because the processor device 720 can retrieve the information from the network. It should be noted that each distributed processor that makes up processor device 720 generally contains its own addressable memory space. It should also be noted that some or all of computer system 710 can be incorporated into an application-specific or general-use integrated circuit.

Optional display 740 is any type of display suitable for interacting with a human user of apparatus 700. Generally, display 740 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method of managing operation of a health care facility, the method comprising the steps of:
acquiring data regarding i) environmental factors in the health care facility and ii) a presence, a location and an identity of personnel in the health care facility using a sensing platform system having a plurality of sensing points throughout the health care facility, wherein the sensing platform is configured to identify the personnel in the health care facility via radio-frequency identification (RFID); and
analyzing the data to provide real-time analytics for managing operation of the health care facility.

2. The method of claim 1, further comprising the step of:
providing customizable reports for managing operation of the health care facility based on analysis of the data.

3. The method of claim 1, wherein the sensing platform comprises a plurality of mote devices located throughout the health care facility, wherein each of the mote devices comprises at least one sensor selected from the group consisting of: temperature sensors, humidity sensors, noise sensors, presence sensors, air flow sensors, pressure sensors, air quality sensors, state of actuator sensors, chemical sensors, and RFID sensors.

4. The method of claim 3, wherein the plurality of mote devices is configured as a mesh network in the health care facility, and wherein each of the mote devices is configured to communicate wirelessly with one or more other mote devices in the mesh network and with a wireless base station.

5. The method of claim 4, wherein wireless communication between the mote devices and between the mote devices and the base station occurs at a fixed time interval so as to conserve power.

6. The method of claim 4, wherein wireless communication between the mote devices and between the mote devices and the base station occurs at a different frequency than a medical equipment operating frequency thus preventing interference.

7. The method of claim 1, wherein the data is analyzed using a measurement and management technology (MMT) platform.

8. The method of claim 1, wherein the environmental factors comprise one or more of temperature, humidity, air quality, and noise in the health care facility, and wherein the data is analyzed to manage patient comfort in the health care facility.

9. The method of claim 1, wherein the environmental factors comprise one or more of i) use of dispensers to dispense hand washing chemicals and ii) a presence of the hand washing chemicals in the health care facility, wherein the hand washing chemicals comprise soap, sanitizers, or disinfectants, and wherein the data is analyzed to prevent nosocomial infections in the health care facility.

10. The method of claim 9, further comprising the step of
assessing compliance with hand washing protocols using the data acquired regarding the use of the dispensers to dispense the hand washing chemicals and the presence of the hand washing chemicals in conjunction with the presence, the location and the identity of the personnel in the health care facility, such that one or more of the use of the dispensers to dispense the hand washing chemicals and the presence of the hand washing chemicals at a given location in the health care facility indicates that the personnel present at the given location complied with the hand washing protocols, while an absence of use of the dispensers to dispense the hand washing chemicals or the presence of the hand washing chemicals at the given location in the health care facility indicates that the personnel present at the given location failed to comply with the hand washing protocols.

11. The method of claim 1, wherein the environmental factors comprise a presence of disinfectants in the health care facility and the data is analyzed to prevent nosocomial infections in the health care facility, and wherein the disinfectant chemicals comprise chemicals employed to clean rooms in the health care facility, the method further comprising the step of:
assessing compliance with protocols for cleaning the rooms in the health care facility using the data acquired regarding the presence of the chemicals employed to clean the rooms in the health care facility, such that the presence of the chemicals employed to clean the rooms in the health care facility at a given location in the health care facility indicates compliance with the protocols for cleaning the patient rooms, while an absence of the chemicals employed to clean the patient rooms at the given location in the health care facility indicates a failure to comply with the protocols for cleaning the rooms in the health care facility.

12. The method of claim 1, wherein the environmental factors comprise a presence of disinfectants in the health care facility and the data is analyzed to prevent nosocomial infections in the health care facility, and wherein the disinfectant chemicals comprise chemicals employed to clean rooms in the health care facility, the method further comprising the step of:
assessing compliance with protocols for cleaning the rooms in the health care facility using the data acquired regarding the presence of the chemicals employed to clean the rooms in the health care facility, such that the presence of the chemicals employed to clean the rooms in the health care facility at a given location in the health care facility for greater than a predetermined minimum duration indicates compliance with the protocols for cleaning the patient rooms, while the presence of the chemicals employed to clean the rooms in the health care facility at the given location in the health care facility for less than a predetermined minimum duration indicates a failure to comply with the protocols for cleaning the rooms in the health care facility.

13. The method of claim 1, further comprising the step of:
using the data regarding the presence, the location and the identity of the personnel in the health care facility to track movement of the personnel throughout the health care facility.

14. The method of claim 13, further comprising the step of:
using the data regarding the presence, the location and the identity of the personnel in the health care facility to determine how long the personnel spent at a given one or more locations in the health care facility over a given time period.

15. The method of claim 13, further comprising the step of:
using the data regarding the presence, the location and the identity of the personnel in the health care facility to determine whether the personnel were present at a given location, at a given time, to administer medication to a patient.

16. The method of claim 1, wherein a certain group of the personnel of the health care facility are needed at a given operating room at a given time to perform a procedure, the method further comprising the step of:
using the data regarding the presence, the location and the identity of the personnel in the health care facility to determine whether any member of the group is missing and, if a member of the group is missing, determining a location in the health care facility of the member of the group that is missing.

17. The method of claim 16, further comprising the step of:
using the data regarding the presence, the location and the identity of the personnel in the health care facility along with a schedule of procedures being performed in the health care facility to determine whether the member of the group that is missing is involved with another procedure and, if the member of the group that is missing is involved with another procedure, estimating when the member of the group that is missing might be available.

18. An apparatus for managing operation of a health care facility, the apparatus comprising:
a memory; and
at least one processor device, coupled to the memory, operative to:
acquire data regarding i) environmental factors in the health care facility and ii) a presence, a location and an identity of personnel in the health care facility using a sensing platform system having a plurality of sensing points throughout the health care facility, wherein the sensing platform is configured to identify the personnel in the health care facility via radio-frequency identification (RFID); and
analyze the data to provide real-time analytics for managing operation of the health care facility.

19. The apparatus of claim 17, wherein the sensing platform comprises a plurality of mote devices located throughout the health care facility, wherein each of the mote devices comprises at least one sensor selected from the group consisting of: temperature sensors, humidity sensors, noise sensors, presence sensors, air flow sensors, pressure sensors, air quality sensors, state of actuator sensors, chemical sensors, and RFID sensors.

20. A computer program product for managing operation of a health care facility, the computer program product comprising a computer readable storage medium having program instructions embodied therewith, the program instructions executable by a computer to cause the computer to:
acquire data regarding i) environmental factors in the health care facility and ii) a presence, a location and an identity of personnel in the health care facility using a sensing platform system having a plurality of sensing points throughout the health care facility, wherein the sensing platform is configured to identify the personnel in the health care facility via radio-frequency identification (RFID); and
analyze the data to provide real-time analytics for managing operation of the health care facility.
